(19) United States
(12) Patent Application Publication
(10) Pub. No.: US 2015/0076145 A1
(43) Pub. Date: Mar. 19, 2015

(54) Container 1

(71) Applicant: William Warren, Frisco, TX (US)

(72) Inventor: William Warren, Frisco, TX (US)

(21) Appl. No.: 14/281,175

(22) Filed: May 19, 2014

Related U.S. Application Data
(60) Provisional application No. 61/855,695, filed on May 21, 2013.

(51) Int. Cl. B65F 1/02; B65F 1/14

(52) U.S. Cl. CPC B65F 1/02; B65F 1/141
USPC 220/9.4

(57) ABSTRACT

A trash container for holding trash which may include an inflatable frame a front flexible wall connected to the inflatable frame, a back flexible wall connected to the inflatable frame and opposed to the front flexible wall, a pair of side flexible walls connected to the inflatable frame and connected to the front flexible wall and the back flexible wall.

### PRIORITY

The present application claims priority under 35 USC section 119 based upon a provisional application with a Ser. No. 61/855,695 which was filed on May 21, 2013.

### FIELD OF THE INVENTION

The present invention relates to trash containers and more particularly to a trash container having flexible walls.

### BACKGROUND

Trash is a common problem around the home, office and out of doors. In order to collect this trash, trash cans have been used. However, these trash cans can be small and generally have rigid sidewalls. The rigid sidewalls prevent the trash cans from being flattened out and stored in a relatively small space. What is needed is a trash can which can be easily deployed and easily stored in a limited space.

### SUMMARY

A trash container for holding trash may include an inflatable frame, a front flexible wall connected to the inflatable frame, a back flexible wall connected to the inflatable frame and opposed to the front flexible wall and a pair of side flexible walls connected to the inflatable frame and connected to the front flexible wall and the back flexible wall.

The trash container may include a rigid bottom wall. The trash container may include a tie down strap.

The trash container may include an inflator/deflator device including a valve to inflate and deflate the frame of the trash container.

The trash container may include a release valve.

The trash container may include a cleat.

The bottom wall may be inclined at an angle between 1° and 90° with respect to a support surface.

A bench support system under inclined wall for pet.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates an exploded view of the trash container of the present invention;

FIG. 2 illustrates an exploded view of the trash container of the present invention;

FIG. 3 illustrates a perspective view of the frame of the trash container of the present invention;

FIG. 4 illustrates a perspective view of the frame of the trash container of the present invention;

FIG. 5 illustrates a perspective view of the frame of the trash container of the present invention;

FIG. 6 illustrates a perspective view of the frame of the trash container of the present invention;

FIG. 7 illustrates a perspective view of the frame of the trash container of the present invention;

FIG. 8 illustrates a perspective view of the frame of the trash container of the present invention;

FIG. 9 illustrates a perspective view of the bottom wall of the trash container of the present invention;

FIG. 10 illustrates a perspective view of the frame of the trash container of the present invention;

FIG. 11 illustrates a perspective view of the frame of the trash container of the present invention;

FIG. 11A illustrates a perspective view of the frame of the trash container of the present invention;

FIG. 12 illustrates a perspective view of the frame of the trash container of the present invention;

FIG. 12A illustrates a perspective view of the frame of the trash container of the present invention.

FIG. 13 illustrates a perspective view of the frame of the trash container of the present invention;

FIG. 13A illustrates a perspective view of the frame of the present invention;

FIG. 14 illustrates a perspective view of the frame of the trash container of the present invention;

FIG. 15 illustrates a perspective view of the frame of the trash container of the present invention;

FIG. 16 illustrates a perspective view of another embodiment of the frame of the trash container of the present invention;

FIG. 17 illustrates a perspective view of another embodiment of the frame of the trash container of the present invention;

FIG. 18 illustrates a perspective view of another embodiment of the frame of the trash container of the present invention;

FIG. 19 illustrates an exploded view of the frame of the trash container of the present invention;

FIG. 20 illustrates an exploded view of the frame of the trash container of the present invention;

FIG. 21 illustrates an exploded view of the frame of the trash container of the present invention;

FIG. 22 illustrates an exploded view of the frame of the trash container of the present invention;

FIG. 23 illustrates an exploded view of the frame of the trash container of the present invention;

FIG. 24 illustrates a view of the bottom wall of the trash container of the present invention;

FIG. 25 illustrates a view of the bottom wall of the present invention;

FIG. 26 illustrates an exploded view of the frame of the present invention;

FIG. 27 illustrates an exploded view of the frame of the present invention;

FIG. 28 illustrates a perspective view of the frame of the present invention;

FIG. 29 illustrates a perspective view of the frame of the present invention;

FIG. 30 illustrates a perspective view of the blow tube of the present invention;

FIG. 4000 illustrates another embodiment of the present invention;

FIG. 4001 illustrates another embodiment of the present invention.

### DETAILED DESCRIPTION

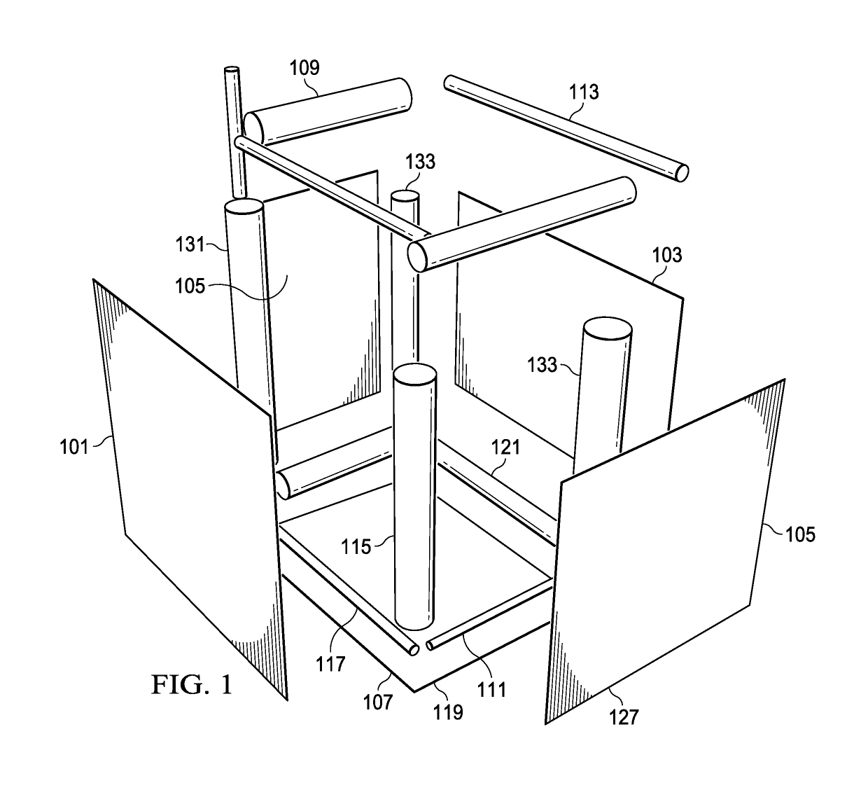

FIG. 1 illustrates a trash container 100 which may include a front flexible wall 101, a back flexible wall 103, and a pair of side flexible walls. The front flexible wall 101, the back flexible wall 103 and the pair of side flexible walls 105 may be formed from a flexible sheet, which may be a plastic, such as a hefty bag or glad bag type material, cloth, a balloon type substance, a woven material polyvinyl material or any other material available. The front flexible wall 101, the back flexible wall 103 and the pair of side flexible walls 105 may be connected to a bottom wall 107 which may be flexible or rigid.

The front flexible wall 101 may be opposed to the back flexible wall 103 and may be connected to the pair of side flexible walls 105, and the back flexible wall may be opposed to the front flexible wall 101 and may be connected to the pair of opposing side walls 105.

The first flexible wall 101, the back flexible wall 103, the pair of side flexible walls 105 and the bottom wall 107 may be connected to a frame 109 which may include a bottom periphery member 111, an opposed top periphery member 113 and a substantially vertical member 115 to connect the bottom periphery member 111 to the top periphery member 113.

The bottom periphery member 111, the top periphery member 113 and the vertical member 115 may be an hollow expandable tube or multiple tubes which may be expanded by fluid pressure such as air and may be returned to the original position (which may be deflated) by the release of the fluid pressure such as air, and each member may be interconnected with at least one other member in order to allow the fluid to flow and pressurize each member simultaneously.

FIG. 1 shows the bottom periphery member 111, the top periphery member 113 and the vertical member 115 which may be optionally a cylinder having a circular cross-section or other appropriate shape.

The bottom periphery member 111 may include a front bottom frame member 117 which may be connected to a side bottom frame member 119 and which may be connected to a first vertical frame member 129 and a second vertical frame member 131 and a back bottom frame member 121 which may be connected to the side bottom frame member 119 and which may be connected to a third vertical frame member 133 and a fourth vertical frame member 135.

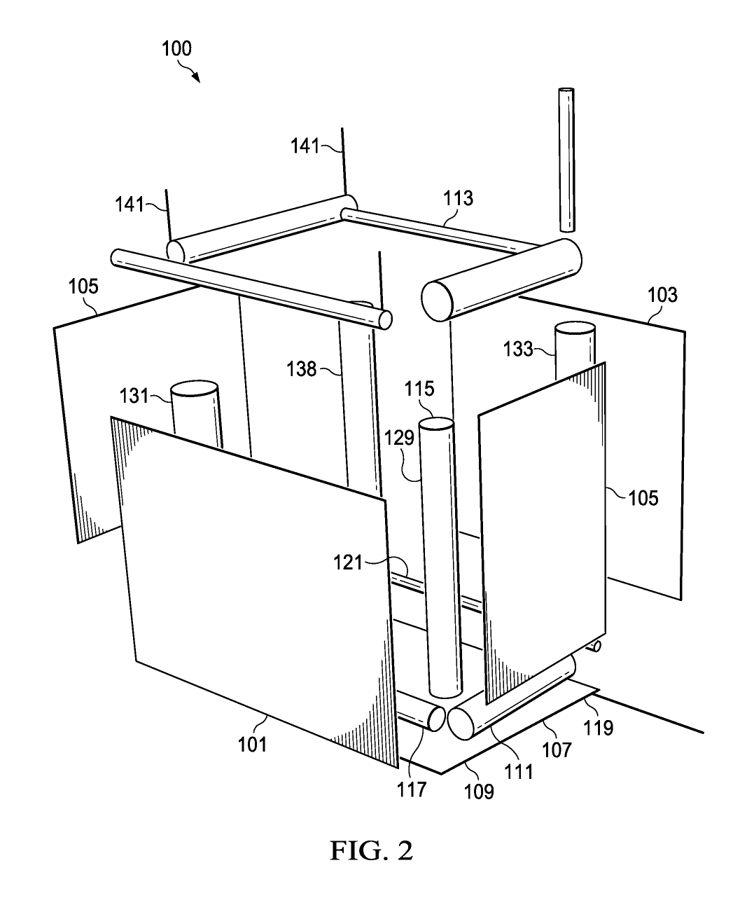

FIG. 2 illustrates a trash container 100 which may include a front flexible wall 101, a back flexible wall 103, and a pair of side flexible walls. The front flexible wall 101, the back flexible wall 103 and the pair of side flexible walls 105 may be formed from a flexible sheet, which may be a plastic, such as a hefty/glad bag type material, cloth, a balloon type substance, a woven material polyvinyl material or any material. The front flexible wall 101, the back flexible wall 103 and the pair of side flexible walls 105 may be connected to a bottom wall 107 which may be flexible or rigid.

The front flexible wall 101 may be opposed to the back flexible wall 103 and may be connected to the pair of side flexible walls 105, and the back flexible wall may be opposed to the front flexible wall 101 and may be connected to the pair of opposing side walls 105.

The first flexible wall 101, the back flexible wall 103, the pair of side flexible walls 105 and the bottom wall 107 may be connected to a frame 109 which may include a bottom periphery member 111, an opposed top periphery member 113 and a substantially vertical member 115 to connect the bottom periphery member 111 to the top periphery member 113.

The bottom periphery member 111, the top periphery member 113 and the vertical member 115 may be an hollow expandable tube or multiple tubes which may be expanded by fluid pressure such as air and may be returned to the original position (which may be deflated) by the release of the fluid pressure such as air, and each member may be interconnected with at least one other member in order to allow the fluid to flow and pressurize each member simultaneously.

FIG. 2 shows the bottom periphery member 111, the top periphery member 113 and the vertical member 115 being optionally a cylinder having a circular cross-section or another appropriate shape.

The bottom periphery member 111 may include a front bottom frame member 117 which may be connected to a side bottom frame member 119 and which may be connected to a first vertical frame member 129 and a second vertical frame member 131 and a back bottom frame member 121 which may be connected to the side bottom frame member 119 and which may be connected to a third vertical frame member 133 and a fourth vertical frame member 135.

FIG. 2 additionally illustrates tied down straps 141 to be used to tie down the trash container 100, and FIG. 2 illustrates an inflation/deflation device 143 to allow the frame 109 to be inflated or deflated which may include an adjustable valve to seal an unseal the frame 109.

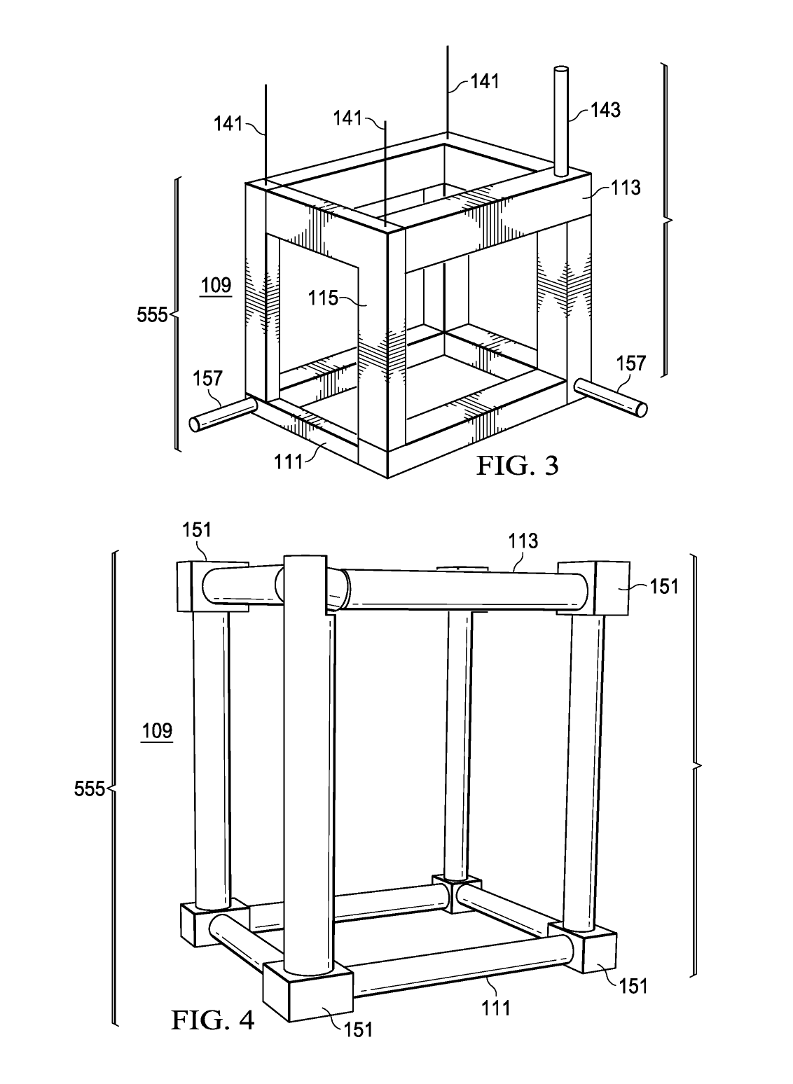

FIG. 3 illustrates the frame 109 which may be formed from a bottom periphery member 111, a top periphery member 113 and a vertical member 115 which may be rectangular in cross-section. The first flexible wall 101, the back flexible wall 103, the pair of side flexible walls 105 and the bottom wall 107 (not shown) may be connected to a frame 109.

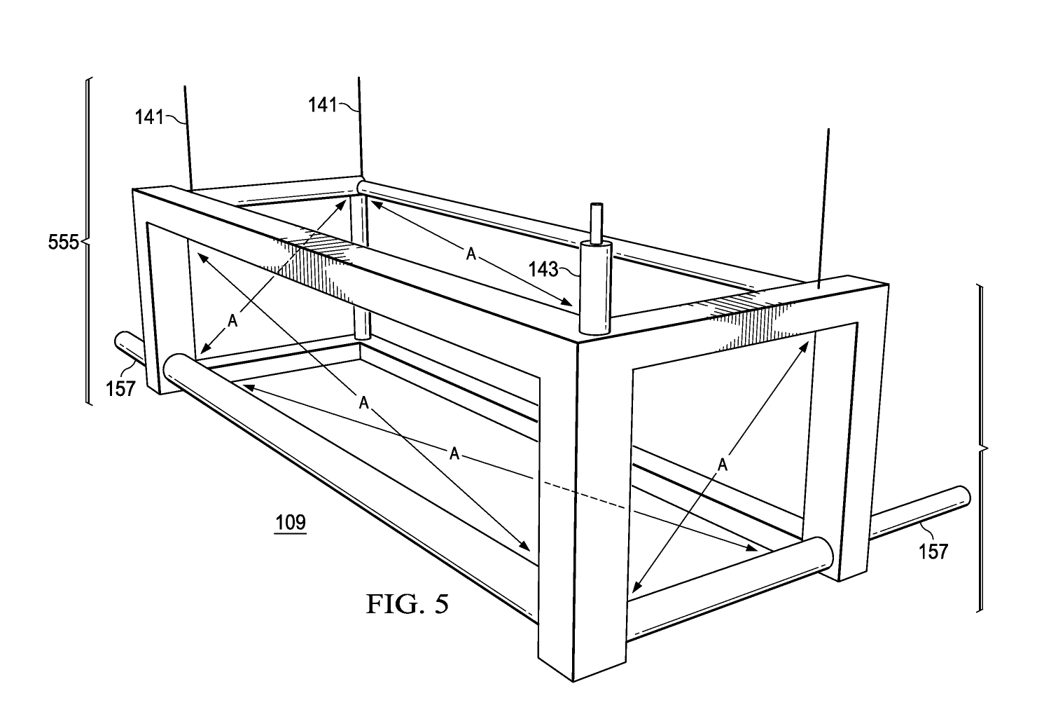

FIG. 4 illustrates the frame 109 which may include the bottom periphery member 111, the top periphery member 113 and the vertical member 115 which may be cylinders and which may be connected by a rectangular member 151.

FIG. 5 illustrates the frame 109 which may include the bottom periphery member 111 which may include cylinder and rectangular portions, the top periphery member 113 which may include cylinder and rectangular (where any other shape) portions and the vertical member 115 which may include cylinder and rectangular portions. The frame 109 may include a multitude of release valves 157.

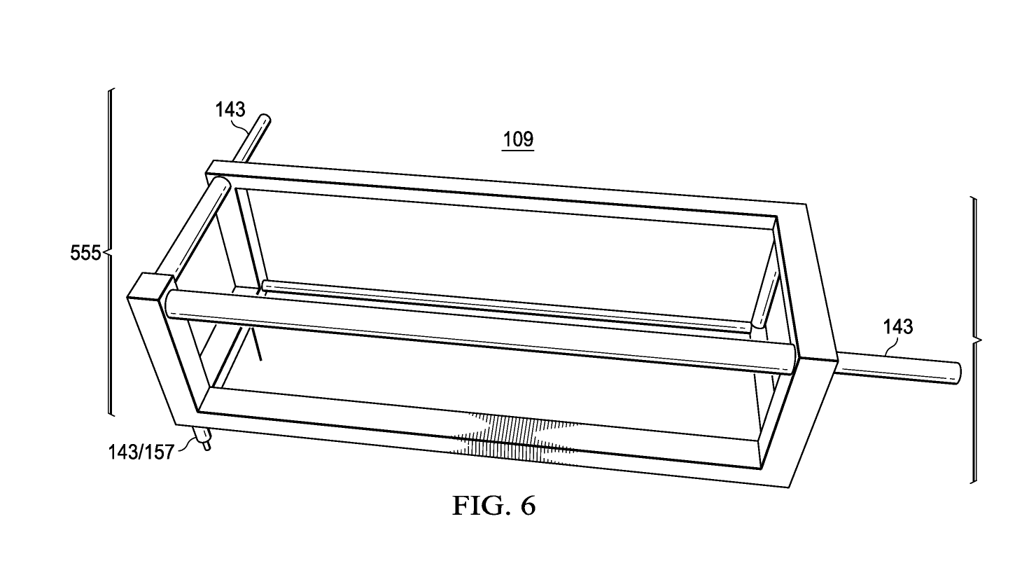

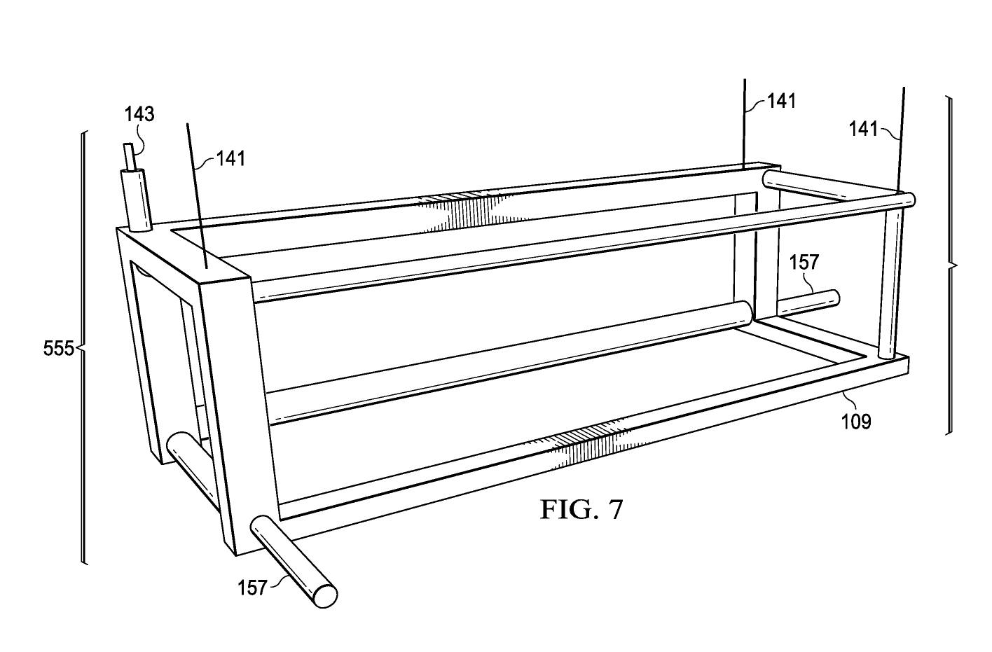

FIG. 6 illustrates the frame 109 of FIG. 5 from a different angle.

The first flexible wall 101, the back flexible wall 103, the pair of side flexible walls 105 and the bottom wall 107 (not shown) may be connected to a frame 109. FIG. 6 illustrates different shapes combinations.

FIG. 7 illustrates the frame 109 of FIG. 5 from a different angle.

The first flexible wall 101, the back flexible wall 103, the pair of side flexible walls 105 and the bottom wall 107 (not shown) may be connected to a frame 109. The present invention may include multiple inflator/deflator devices 143 for blowup and deflation. The frame 109 may be any appropriate size or shape. Element 157 is a quick deflator.

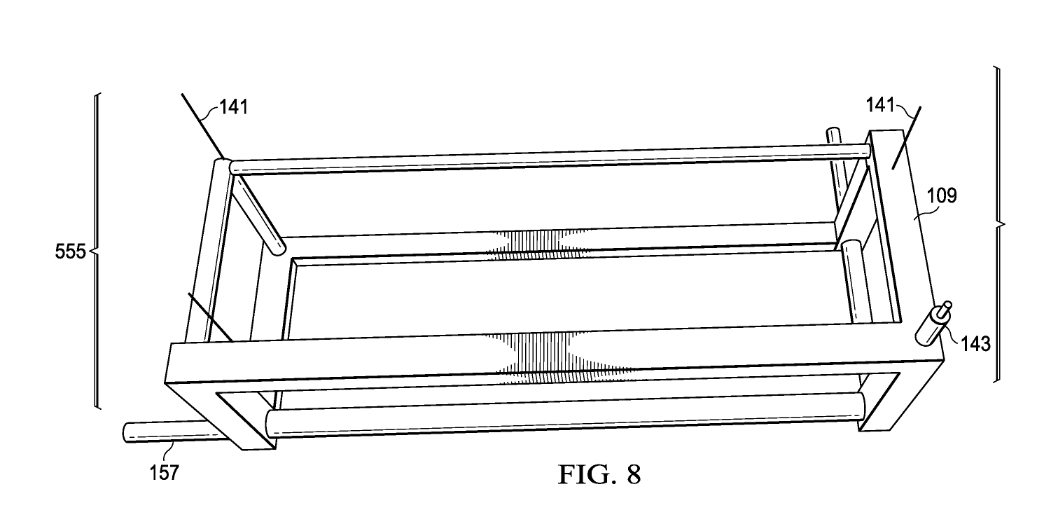

FIG. 8 illustrates the frame 109 of FIG. 5 from a different angle. The frame 109 may be any appropriate size or shape.

The first flexible wall 101, the back flexible wall 103, the pair of side flexible walls 105 and the bottom wall 107 (not shown) may be connected to a frame 109.

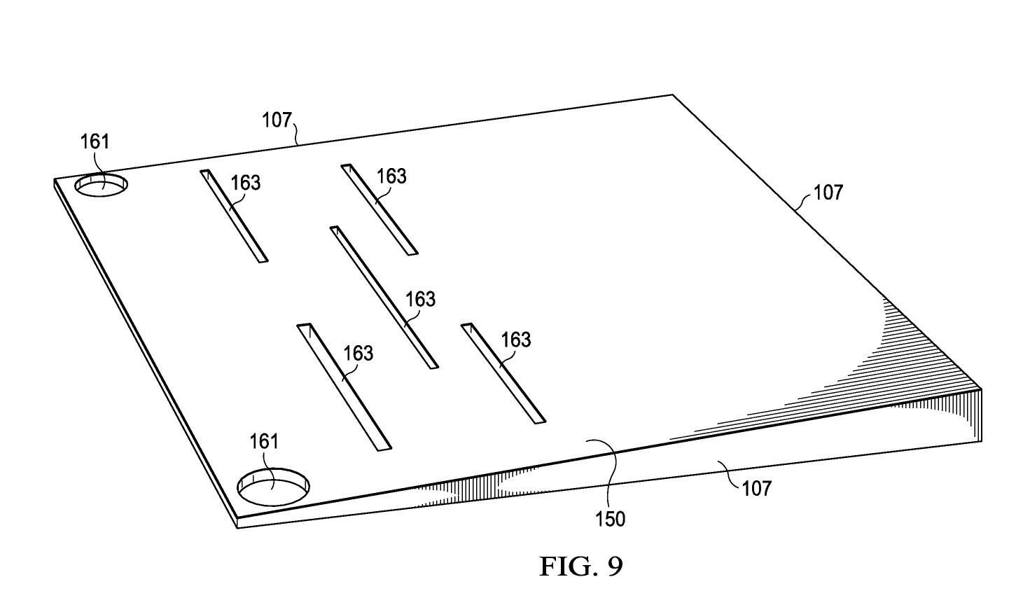

FIG. 9 illustrates the bottom wall 107 of the frame 109 which may be substantially flat or may be inclined (as illustrated) to allow any liquids which has been placed into the trash container 101 to flow to the lowest level of the bottom wall 107 and out of the trash container. The bottom wall 107 may include a multitude of slits 163 and may include an aperture 161 which may cooperate with the vertical member 115. FIG. 9 additionally illustrates a mat 150 which may be absorbing or non-absorbing to prevent liquids from escaping from the frame 109 on to the support surface.

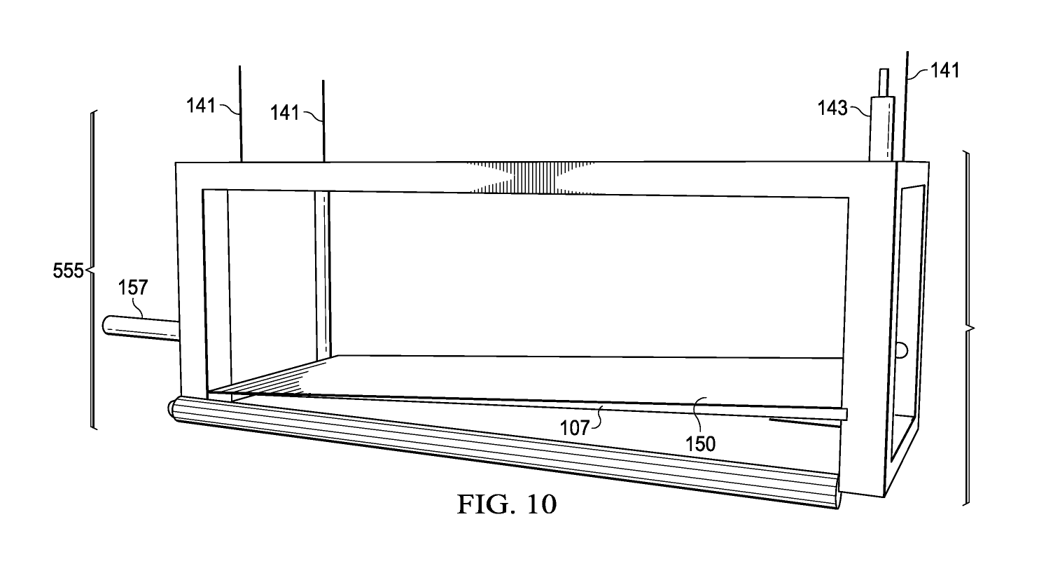

FIG. 10 illustrates a perspective view of the frame 109 which may include an inclined bottom wall 107, a multitude of tie down straps 141, a inflator/deflator device 143 and a release valve 157. FIG. 10 additionally illustrates a mat 150 which may be absorbing or non-absorbing to prevent liquids from escaping from the frame 109 on to the support surface. The mat 150 may be positioned between the bottom wall 107 and the bottom layer. The tied down straps may be used to gather the container together in order to conveniently dispose of the contents of the container.

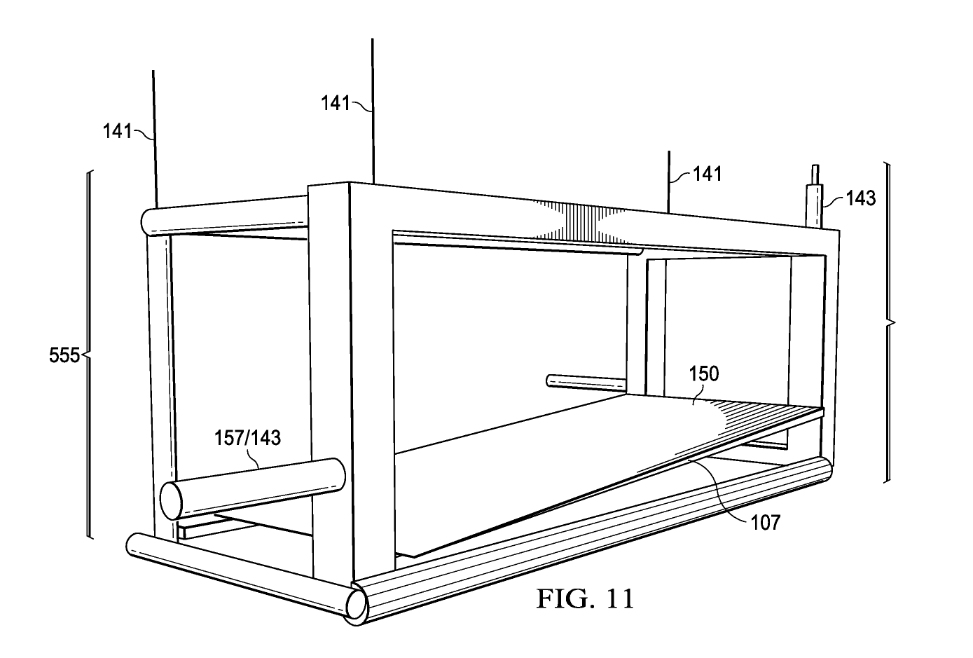

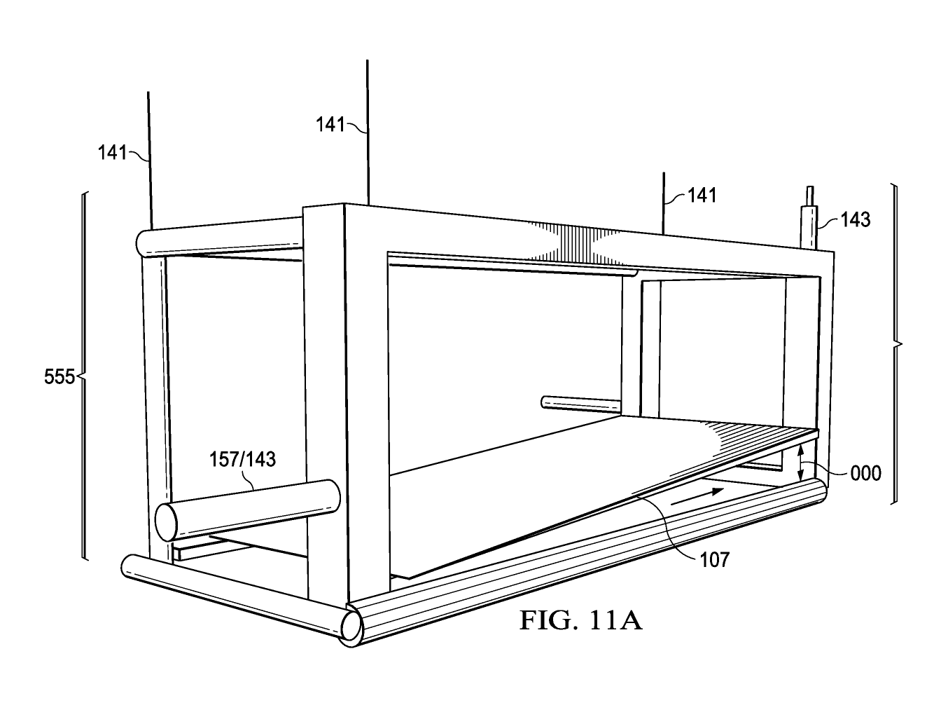

FIG. 11 illustrates a perspective view of the frame 109 which may include an inclined bottom wall 107, a multitude of tied down straps 141, a inflator/deflator device 143 and a release valve 157.

FIG. 11a illustrates an absorption system which may be positioned within the cavity 000 and which may be positioned under the rigid or non-rigid bottom wall 107.

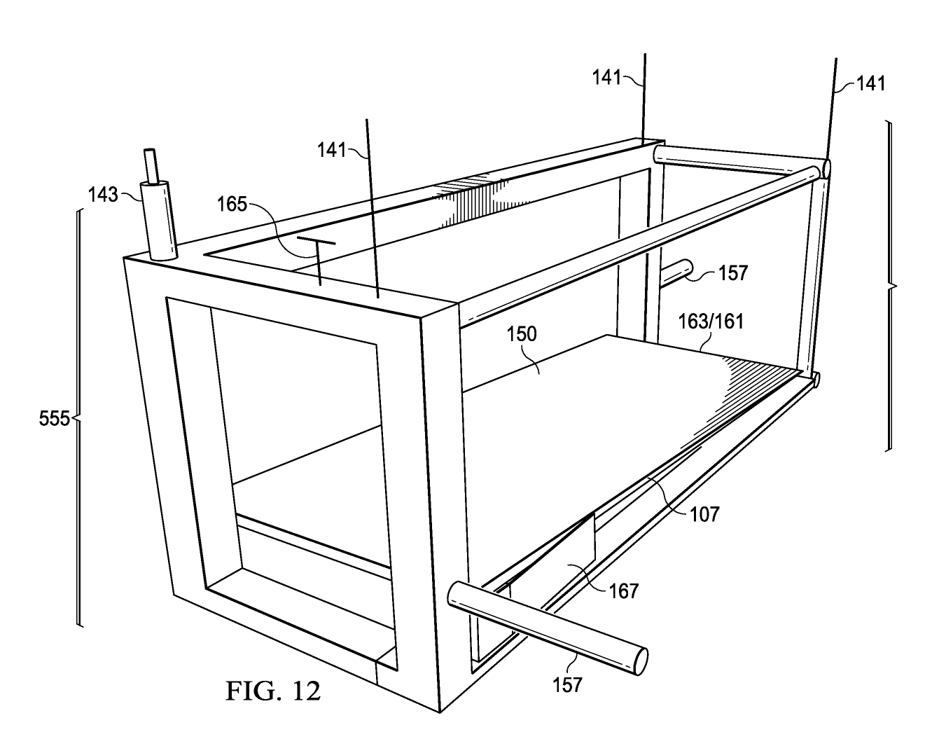

FIG. 12 illustrates a perspective view of the frame 109 which may include an inclined bottom wall 107, a multitude of tied down straps 141, a inflator/deflator device 143 and a multitude of release valves 157. Additionally, FIG. 12 illustrates a support member 167 which may be a rectangle to support the bottom wall 107 and support the inclined aspect of the inclined bottom wall 107. FIG. 12 illustrates a cleat 165 to attach to a dog lease. The support member 167 may be inflatable in order to support a pet. FIG. 12 additionally illustrates a mat 150 which may be absorbing or non-absorbing to prevent liquids and or solid waste material from escaping from the frame 109 on to the support surface.

FIG. 12 illustrates a support system 167 which may be mounted under the bottom wall 107 and may be positioned within the cavity 000.

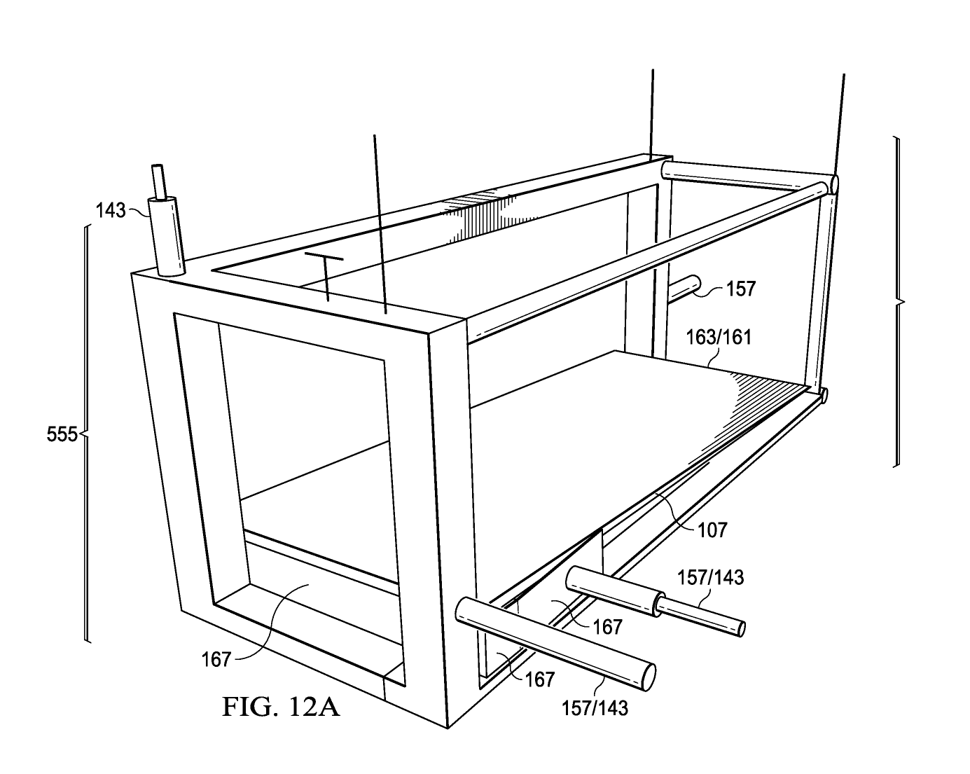

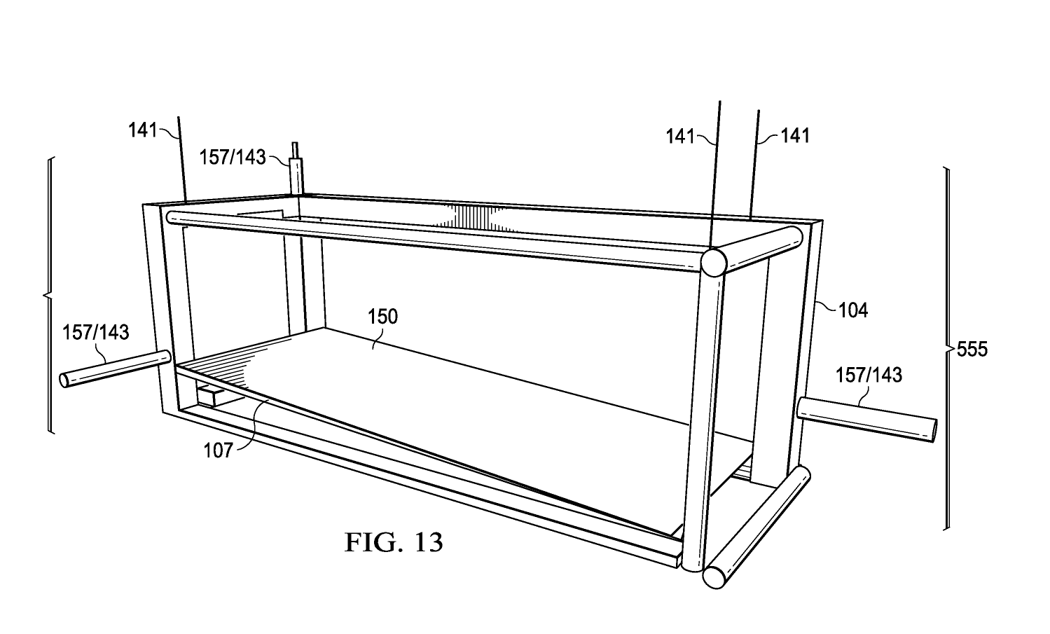

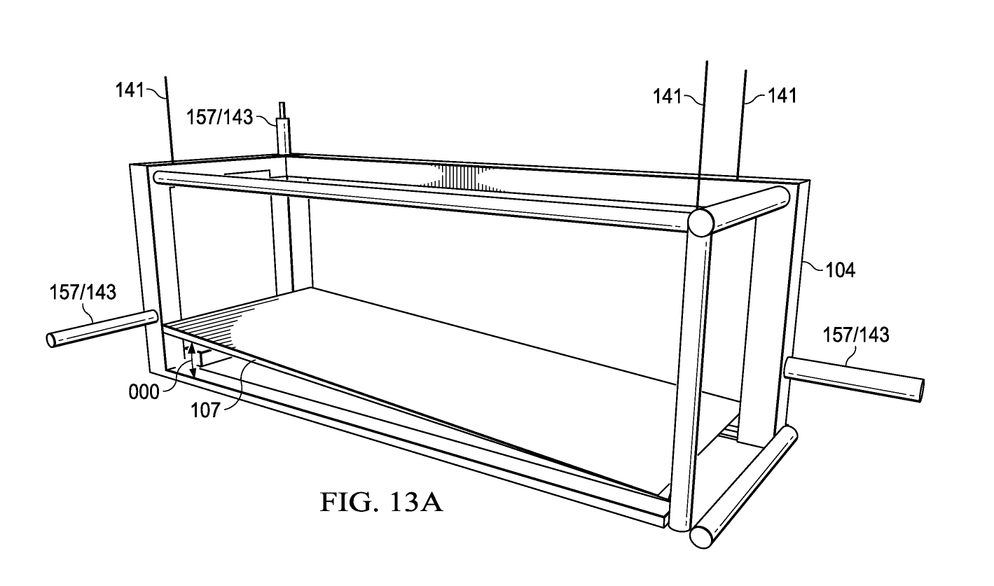

FIG. 13 illustrates a perspective view of the frame 109 which may include an inclined bottom wall 107, a multitude of tied down straps 141, a inflator/deflator device 143 and a release valve 157.

FIG. 13 illustrates a perspective view of the frame 109 which may include an inclined bottom wall 107, a multitude of tied down straps 141 a inflator/deflator device 143 and a release valve 157.

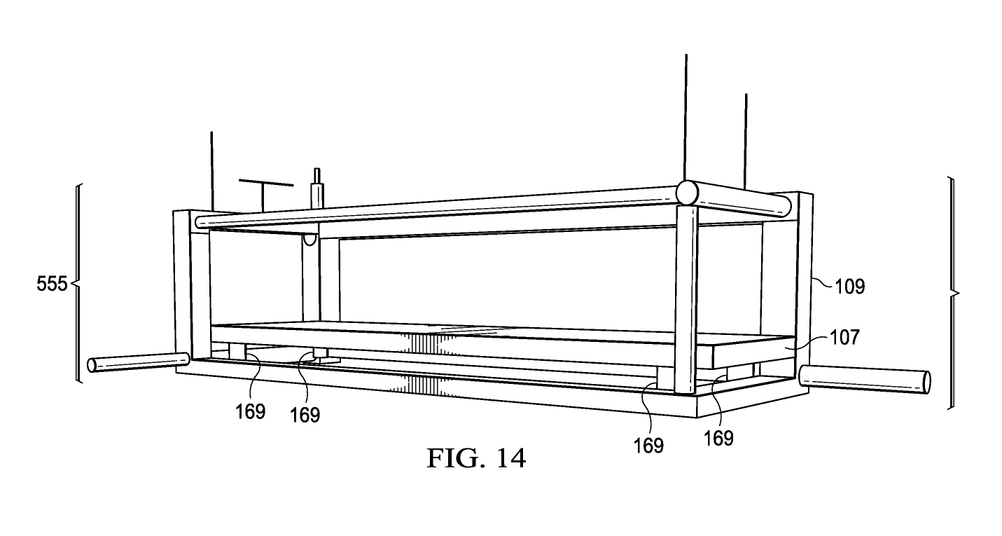

FIG. 14 illustrates a perspective view of the frame 109 which may include a bottom wall 107 which may be supported by a multitude of floor support 169 (inflatable support surface), a multitude of tied down straps 141, a inflator/deflator device 143 and a multitude of release valves 157. FIG. 14 illustrates a cleat 165 to attach to a dog lease.

FIG. 15 illustrates a perspective view of the frame 109 which may include an inclined bottom wall 107 which may be supported by a multitude of floor support 169(inflatable support surface), a multitude of tied down straps 141, a inflator/deflator device 143 and a release valve 157.

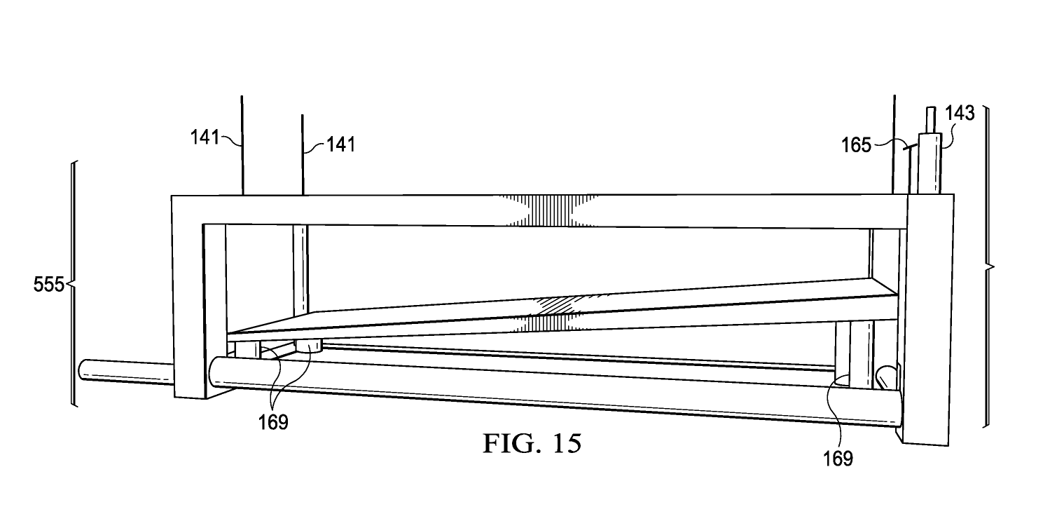

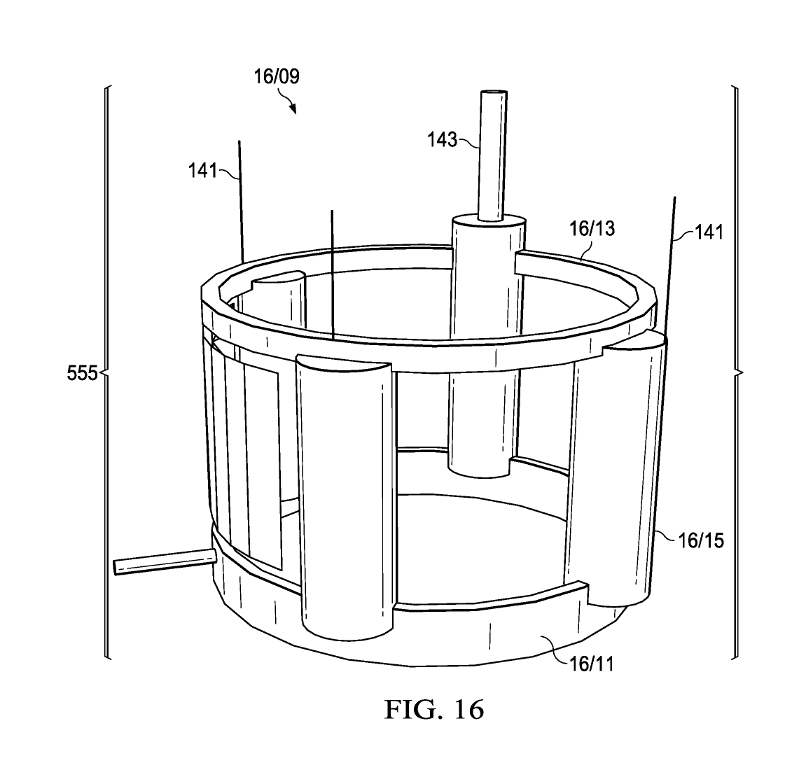

FIG. 16 shows the bottom periphery member 16111 which may be formed in a substantial ring, the top periphery member 16113 which may be formed in a substantial ring and the vertical member 16115 being a cylinder having a circular cross-section.

FIG. 16 additionally illustrates tied down straps 141 to be used to tie down the trash container 100, and FIG. 16 illustrates an inflation/deflation device 143 to allow the frame 16109 to be inflated or deflated which may include an adjustable valve to seal an unseal the frame 109.

FIG. 17 shows the bottom periphery member 16111 which may be formed in a substantial ring, the top periphery member 16113 which may be formed in a substantial ring and the vertical member 16115 being a cylinder having a circular cross-section.

FIG. 17 additionally illustrates tied down straps 141 to be used to tie down the trash container 100, and FIG. 28 illustrates an inflation/deflation device 143 to allow the frame 16109 to be inflated or deflated which may include an adjustable valve to seal an unseal the frame 109.

FIG. 18 shows the bottom periphery member 16111 which may be formed in a substantial ring, the top periphery member 16113 which may be formed in a substantial ring and the vertical member 16115 being a cylinder having a circular cross-section.

FIG. 18 additionally illustrates tied down straps 141 to be used to tie down the trash container 100, and FIG. 18 illustrates an inflation/deflation device 143 to allow the frame 16109 to be inflated or deflated which may include an adjustable valve to seal an unseal the frame 109.

FIG. 18 illustrates a portion of the sidewall 1801 which may extend around the periphery of the frame 16109.

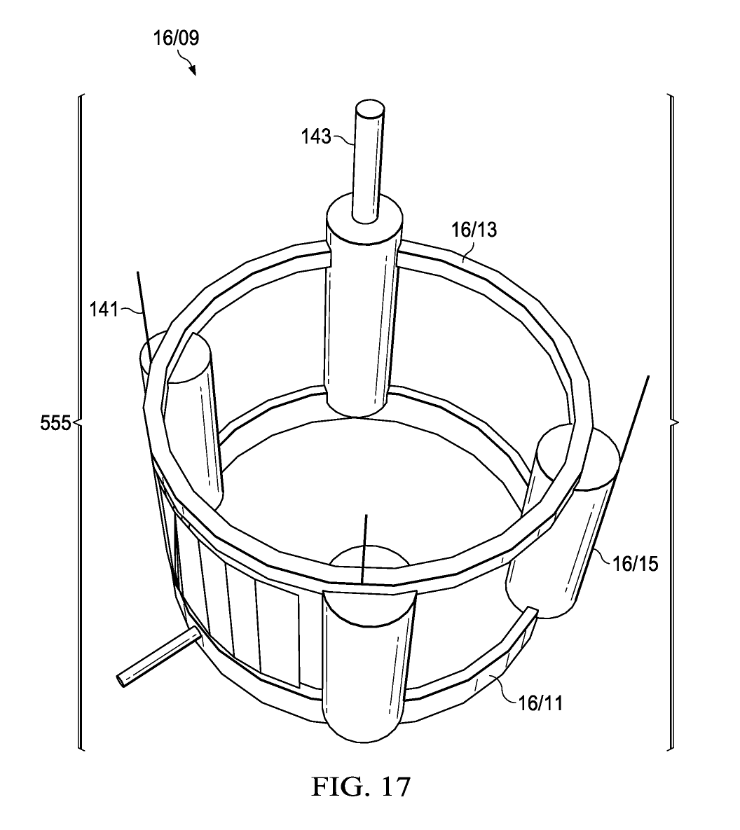

FIG. 19 illustrates a base member 1901 which may include a back cylinder support 1901 a pair of opposing side walls 1903 which may be inclined and extend from the back cylinder support 1901 to the front wall 1905. The end of the base member 1901 may include a release valve 157, and the base member 1901 may support the bottom wall 107 as illustrated in FIG. 9. The base member 1901 may be connected to the vertical member 115 so that the base member 101, the vertical member 115 and the top periphery member 113 may be inflated/deflated simultaneously.

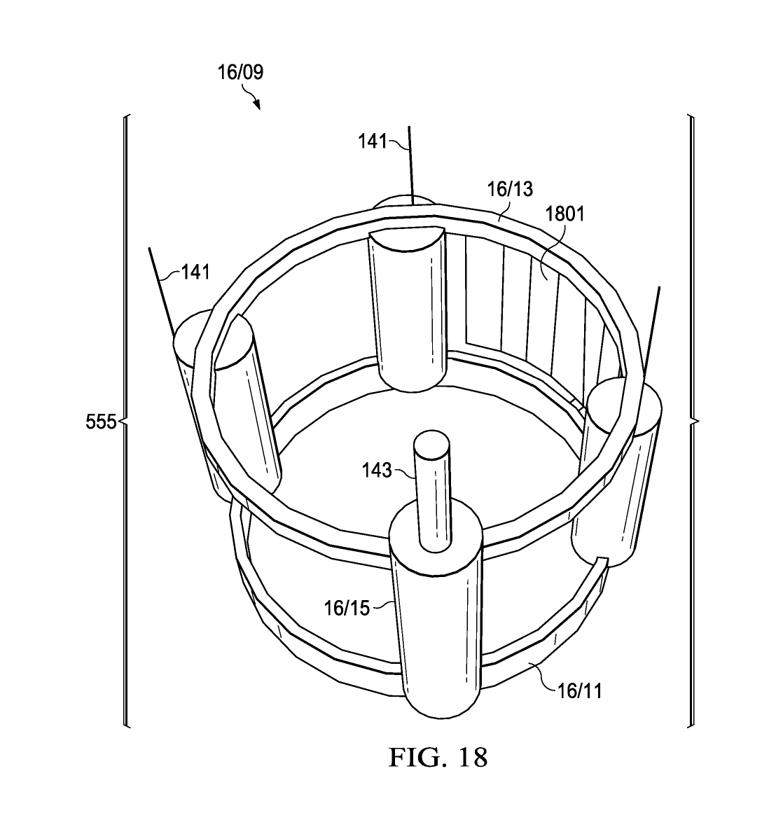

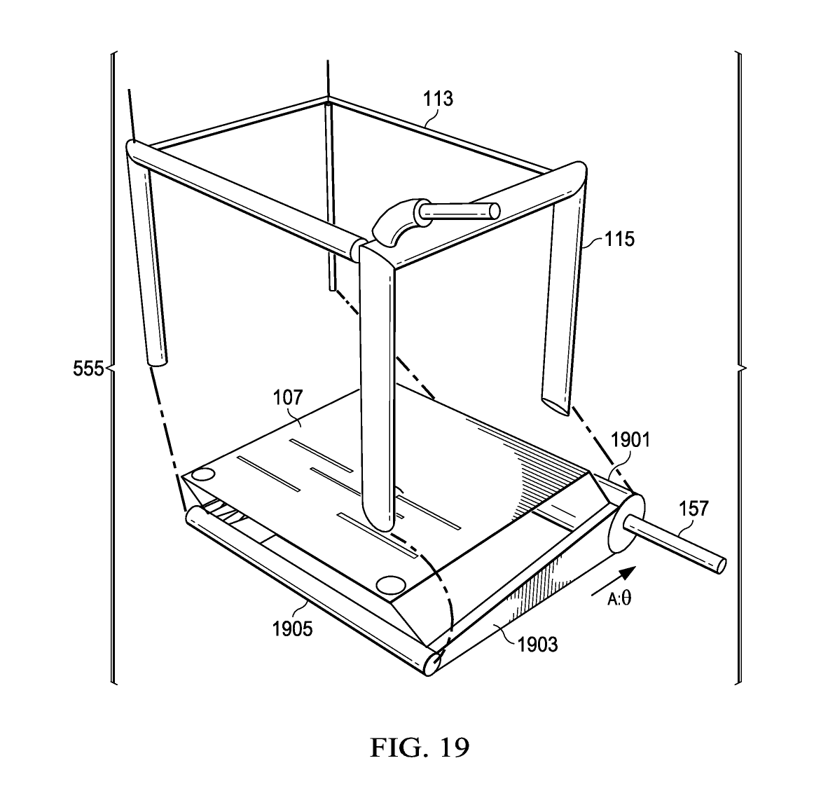

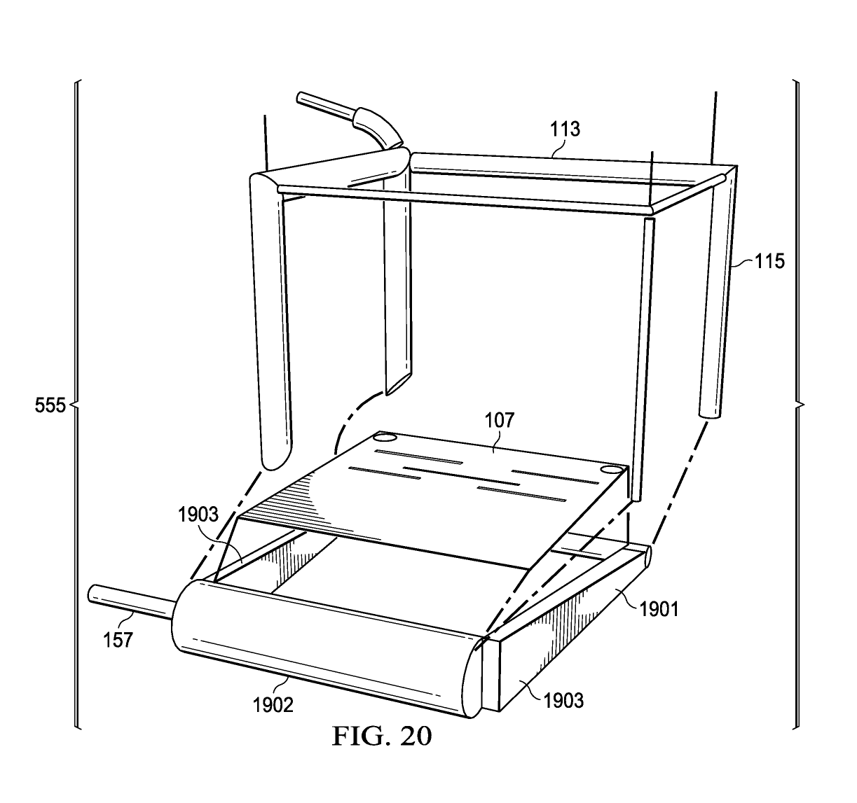

FIG. 20 illustrates a base member 1901 which may include a back cylinder support 1902 a pair of opposing side walls 1903 which may be inclined and extend from the back cylinder support 1901 to the front wall 1905(not shown). The end of the base member 1901 may include a release valve 157, and the base member 1901 may support the bottom wall 107 as illustrated in FIG. 9. The base member 1901 may be connected to the vertical member 115 so that the base member 101, the vertical member 115 and the top periphery member 113 may be inflated/deflated simultaneously.

FIG. 21 illustrates a base member 1901 which may include a back cylinder support 1902, a pair of opposing side walls 1903 which may be inclined and extend from the back cylinder support 1901 to the front wall 1905. The end of the base member 1901 may include a release valve 157, and the base member 1901 may support the bottom wall 107 as illustrated in FIG. 9. The base member 1901 may be connected to the vertical member 115 so that the base member 101, the vertical member 115 and the top periphery member 113 may be inflated/deflated simultaneously.

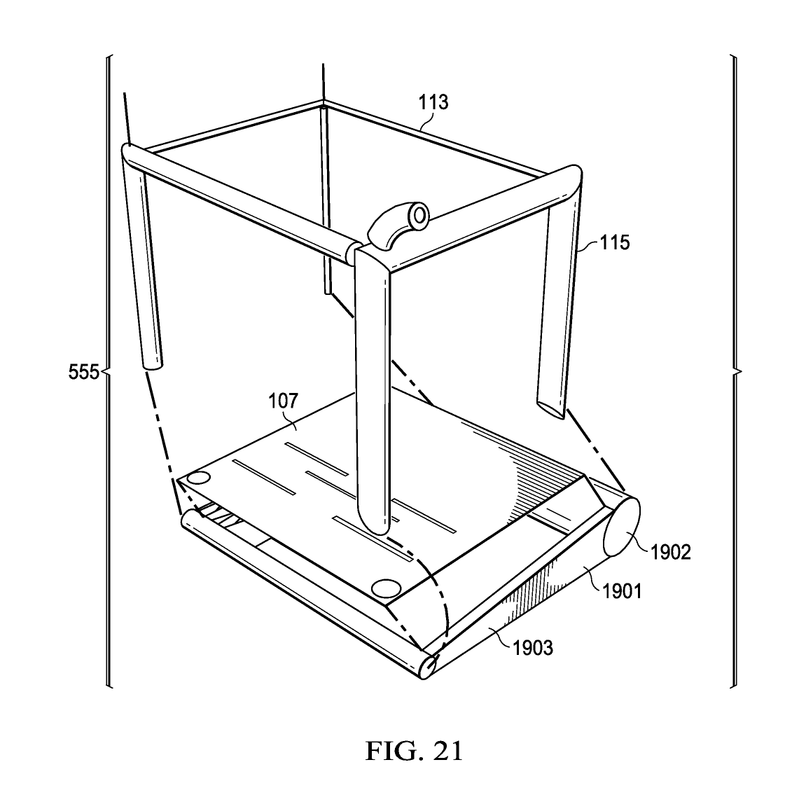

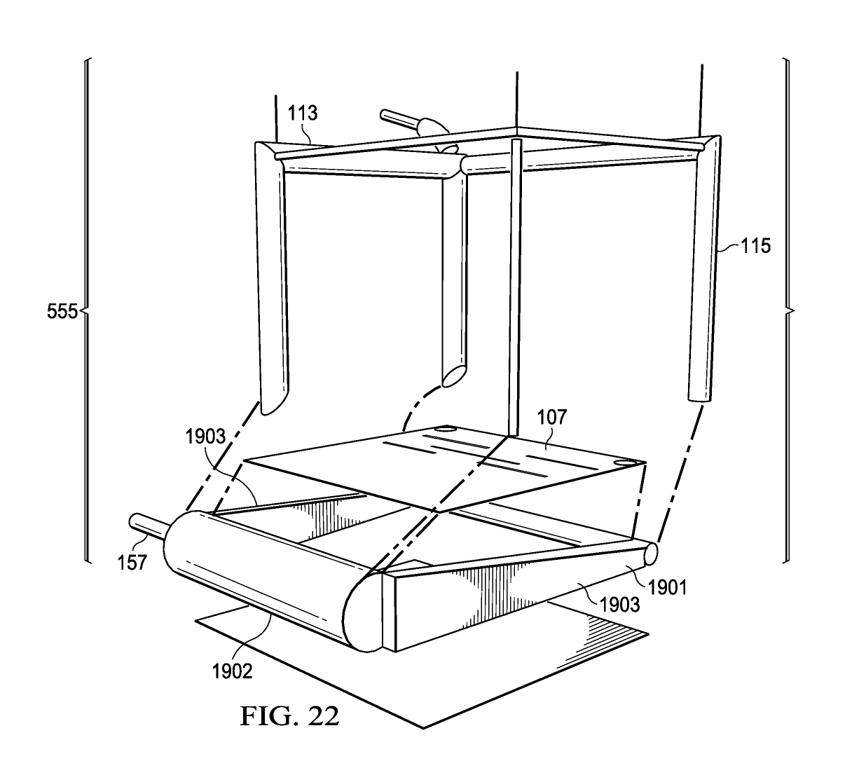

FIG. 22 illustrates a base member 1901 which may include a back cylinder support 1902 or ay shape, a pair of opposing side walls 1903 which may be inclined and extend from the back cylinder support 1901 to the front wall 1905. The end of the base member 1901 may include a release valve 157, and the base member 1902, may support the bottom wall 107 as illustrated in FIG. 9. The base member 1901 may be connected to the vertical member 115 so that the base member 101, the vertical member 115 and the top periphery member 113 may be inflated/deflated simultaneously.

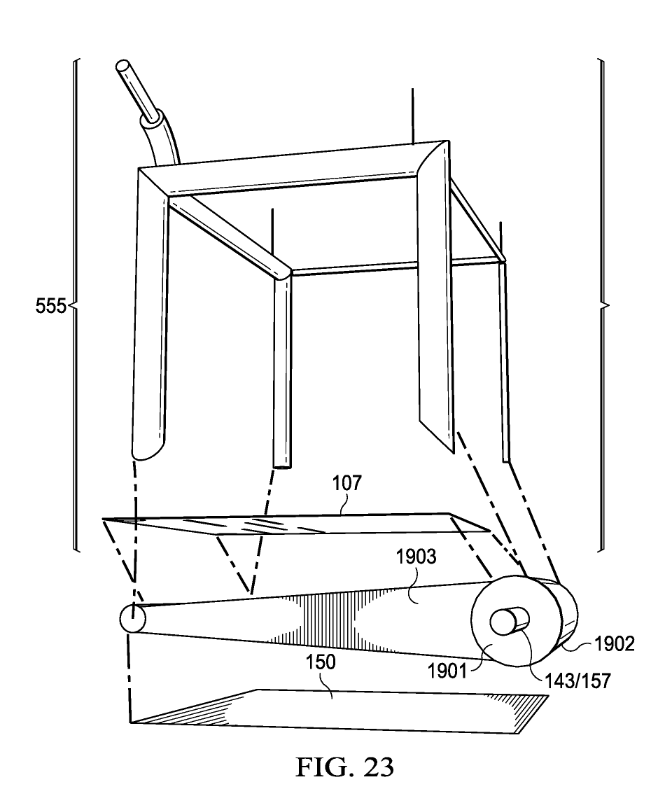

FIG. 23 illustrates a base member 1901 which may include a back cylinder support 1902, a pair of opposing side walls 1903 which may be inclined and extend from the back cylinder support 1901 to the front wall 1905. The end of the base member 1901 may include a release valve 157, and the base member 1901 may support the bottom wall 107 as illustrated in FIG. 9. The base member 1901 may be connected to the vertical member 115 so that the base member 101, the vertical member 115 and the top periphery member 113 may be inflated/deflated simultaneously.

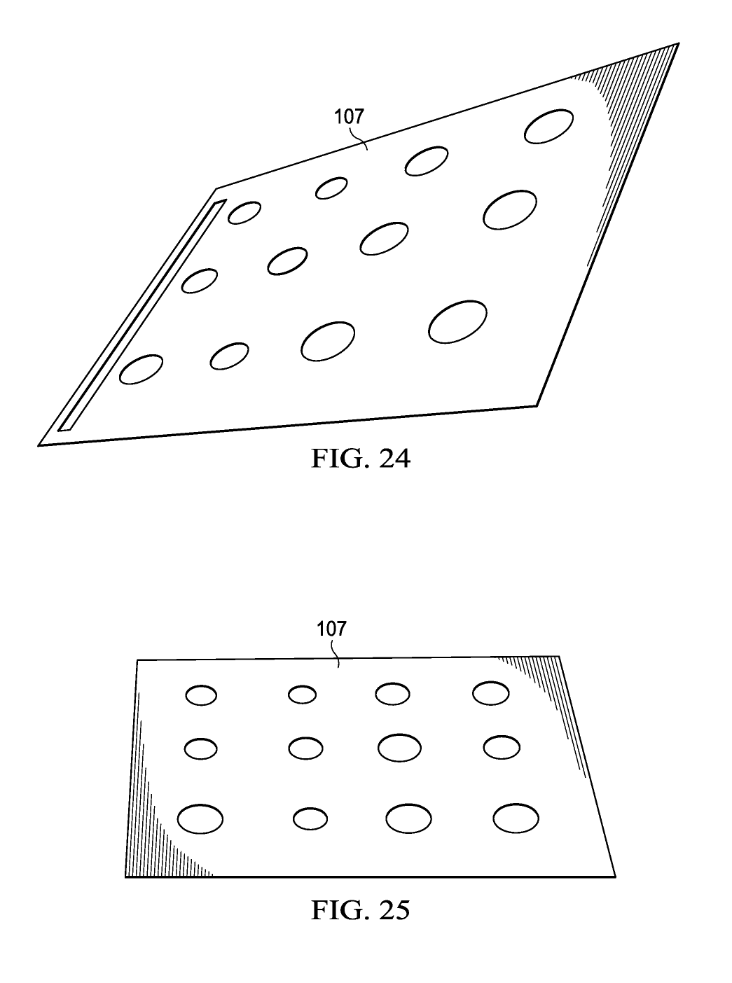

FIG. 24 illustrates the bottom wall 107 having a multitude of apertures and a slot.

FIG. 25 illustrates the bottom wall 107 having a multitude of apertures.

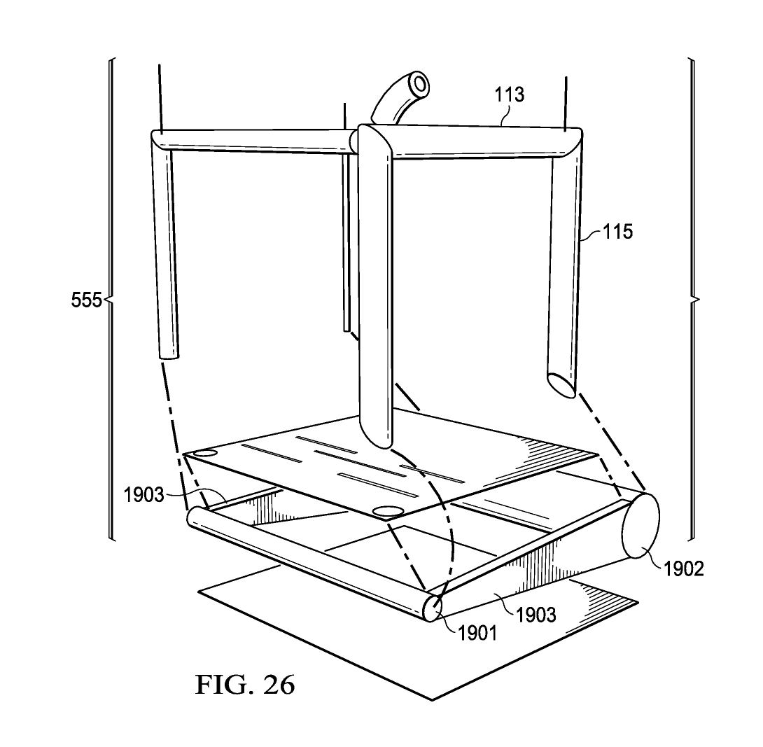

FIG. 26 illustrates a base member 1901 which may include a back cylinder support 1902, a pair of opposing side walls 1903 which may be inclined and extend from the back cylinder support 1901 to the front wall 1905. The end of the base member 1901 may include a release valve 157, and the base member 1901 may support the bottom wall 107 as illustrated in FIG. 9. The base member 1901 may be connected to the vertical member 115 so that the base member 101, the vertical member 115 and the top periphery member 113 may be inflated/deflated simultaneously.

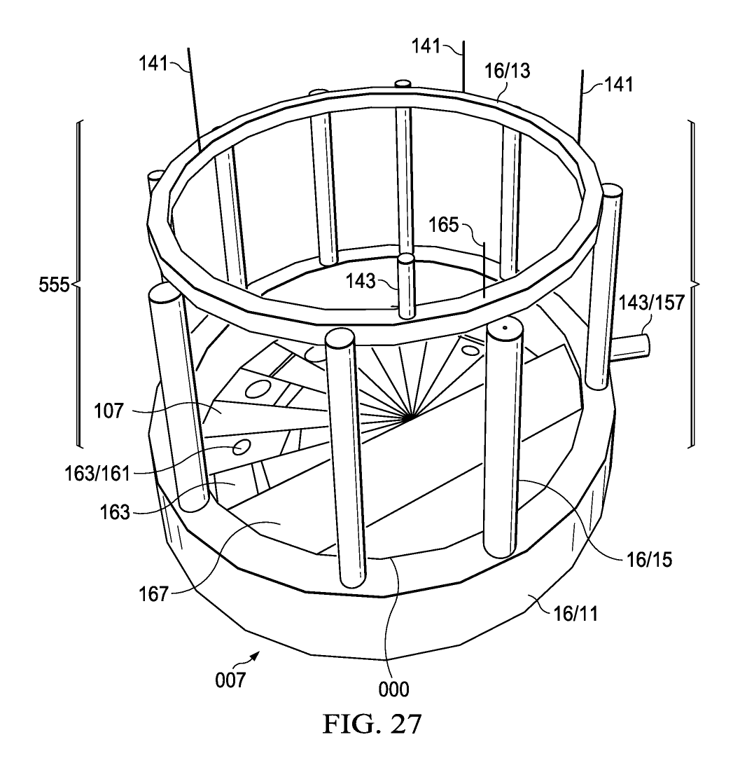

FIG. 27 shows the periphery member 16111 which may be formed in a substantial ring of any geometric shape. The top periphery member 16113 which may be formed in a substantial ring of any shape or size and the vertical member 16115 could be a cylinder having a circular cross-section or could be in geometrical shape.

FIG. 27 additionally illustrates tied down straps 141 to be used to tie down the trash container for easy disposal, and FIG. 27 illustrates an inflation/deflation device 143 to allow the frame 1000 to be inflated or deflated which may include an adjustable valve to seal an unseal the frame 1000.

FIG. 27 makes a point of showing a support area 167 which may or not be inflated with frame 1000, declining down to a flexible or rigid support 107 declining possibly at a 1 degree angle to 90 degrees in relationship to the lowest floor to support area 007., and additionally holes or slits 163,161 ? will catch liquids or solids trapped between 107 and 007. An additionally supports 107 and 007 there may or may not be 00 a liquid absorption material.

FIG. 28 illustrates the process of a liquid or solid being drained to 163 and 161 holes and slits 167 is the support area which may or may not be inflated with the frame 1000, the liquids can easily transformed to support 107, and trapped between 107 and 007., with possible liquid or solid absorption device 000.

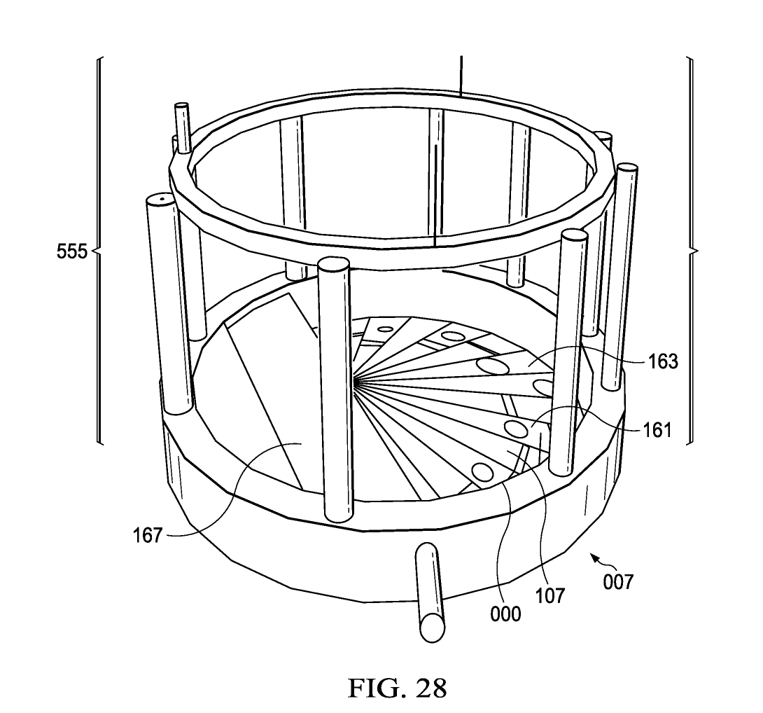

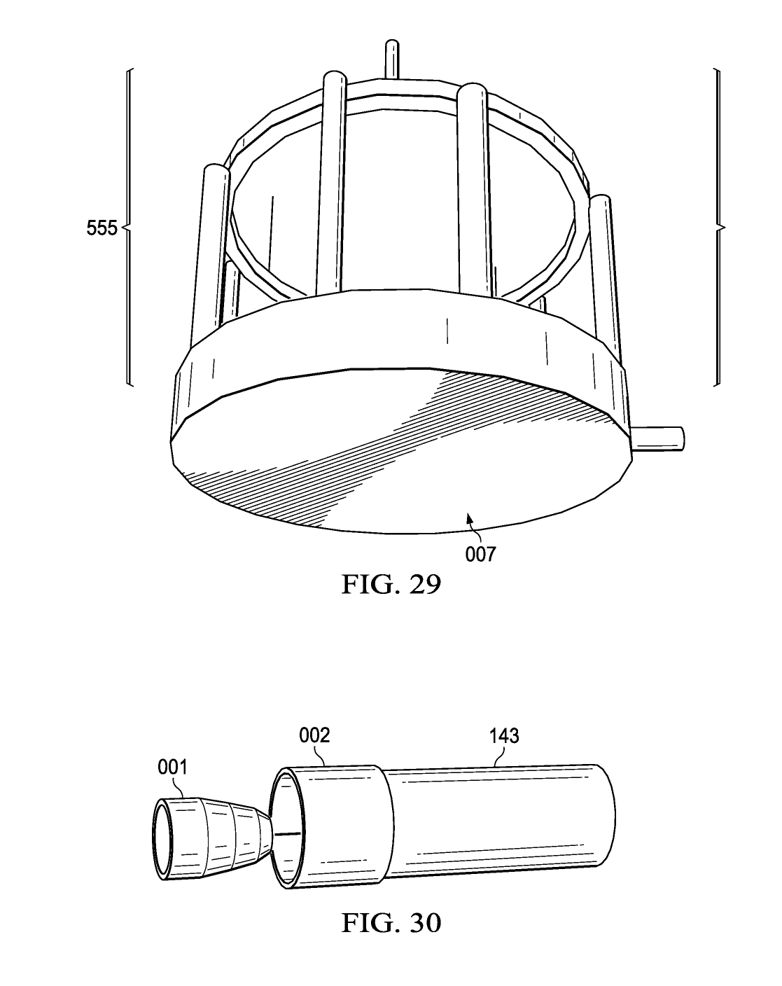

FIG. 29 illustrates the support 007, liquids and solids are trapped above 007 and below 107.

FIG. 30 shows a plug 001 and the blow tube 143 with end 002 which may or not be rigid to allow for better air flow. A cot or automatic electric air machine or other liquid or air devices may be used.

FIG. 12A illustrates 167 a support system which may or may not be inflated by tubes 157/143.

FIG. 11A illustrates an absorption system that might be located in space 000, under rigid or non-rigid 107.

FIG. 13A show another angle of 000 in relation to 107.

Bracket 555

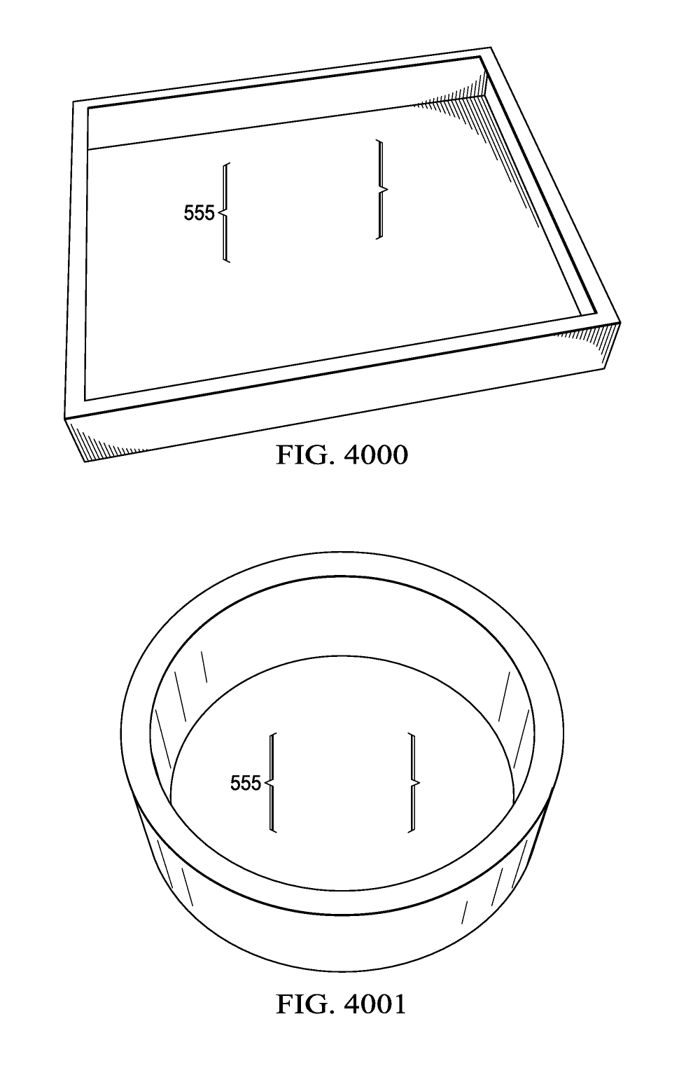

FIG. 4000 illustrates the sheathing or outer covering of plastic or any other type material that will serve as a skin to hold trash.

FIG. 4001 same as 4000 but this is to illustrate different shapes like circle or oval or other geometric shape.

FIG. 3 is missing the sheathing that goes around the blow up tubes to hold trash in place. Looking at FIGS. 1 and 2, the sheathing is in place. The opposing walls 105 and the walls 101 and 103 and the bottom wall 107. The sheathing was left off on purpose to show the inside of device without walls blocking the blow tubes.

FIG. 5 is the same as FIG. 3 for sheathing.

FIG. 6 is the same as FIG. 3 for sheathing.

FIG. 7 is the same as FIG. 3 for sheathing.

FIG. 8 is the same as FIG. 3 for sheathing.

FIG. 9 is the same as FIG. 3 for sheathing.

FIG. 10 is the same as FIG. 3 for sheathing.

FIG. 11 is the same as FIG. 3 for sheathing.

FIG. 12 is the same as FIG. 3 for sheathing.

FIG. 13 is the same as FIG. 3 for sheathing.

FIG. 14 is the same as FIG. 3 for sheathing.

FIG. 15 is the same as FIG. 3 for sheathing.

FIG. 16 is the same as FIG. 3 for sheathing.

FIG. 17 is the same as FIG. 3 for sheathing.

FIG. 18 is the same as FIG. 3 for sheathing.

FIG. 19 is the same as FIG. 3 for sheathing.

FIG. 20 is the same as FIG. 3 for sheathing.

FIG. 21 is the same as FIG. 3 for sheathing.

FIG. 22 is the same as FIG. 3 for sheathing.

FIG. 23 is the same as FIG. 3 for sheathing.

FIG. 24 is the same as FIG. 3 for sheathing.

FIG. 25 is the same as FIG. 3 for sheathing.

FIG. 26 is the same as FIG. 3 for sheathing.

FIG. 27 is the same as FIG. 3 for sheathing.

FIG. 16 should have a different sheathing that is round and a bottom sheathing to hold in cavity.

FIG. 17 should have a different sheathing that is round and a bottom sheathing to hold waste in cavity.

FIG. 18 should have a different sheathing that is round and a bottom sheathing to hold waste in cavity.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A trash container for holding trash, comprising:
an inflatable frame;
a front flexible wall connected to the inflatable frame;
a back flexible wall connected to the inflatable frame and opposed to the front flexible wall;
a pair of side flexible walls connected to the inflatable frame and connected to the front flexible wall and the back flexible wall.

2. A trash container for holding trash as in claim 1, wherein the trash container flexible walls may have uniform heights or walls s that vary in height in relation to one another

3. A trash container for holding trash as in claim 1, wherein the trash container includes a tie down strap.

4. A trash container for holding trash as in claim 1, wherein the trash container includes a inflator/deflator device including a valve to inflate and deflate the frame of the trash container.

5. A trash container for holding trash as in claim 1, when the trash container includes a quick release valve.

6. A trash container for holding trash as in claim 1, wherein the trash container includes a cleat.

7. A trash container for holding trash as in claim 1, wherein middle floor or wall that is parallel to bottom floor.

8. A trash container for holding trash as in claim 1, wherein the middle wall or floor above bottom floor that is rigid or non-rigid is inclined at an angle with respect to bottom floor.

9. A trash container for holding trash as in claim 1, wherein the trash container includes a rigid or non-rigid middle wall or floor, for holding material above the bottom floor that is parallel, or non-parallel to bottom floor.

10. A trash container for holding trash as in claim 1, wherein the trash container includes the middle section or wall right above the bottom floor, that has a support or bench, type inflatable system.

11. A trash container for holding trash as in claim 1, wherein the trash container includes a middle floor or wall with holes or slits to let solids or liquids through.

12. A trash container for holding trash as in claim 1, wherein the trash container includes a bench support system.

13. A trash container for holding trash as in claim 1, wherein a bench support (to support pet) system that inflates and deflates separate from the inflatable frame, separate blow tube.

14. A trash container for holding trash as in claim 1, wherein a bench support system (to support pet) that can be inflatable and deflate that is continuous and inflated with inflatable frame.

15. A trash container for holding trash as in claim 1, wherein a flexible or non-flexible supports or spacers to separate outer flexible wall from inner flexible wall or spacers would exist if needed.

16. A trash container for holding trash as in claim 1, wherein a flexible material with supports or separators to create a mechanism to separate the flexible walls, where needed to keep the frame from collapsing a wall onto another one.

17. A trash container for holding trash as in claim 1, wherein the secondary floor above bottom floor that hold the fluids and solid waste, has a material that supports or separators or spaces the floor from the very bottom floor, can be flexible or non-flexible material, located above the space for holding the waste.

18. A trash container for holding trash as in claim 1, wherein a space or holding area under secondary floor and above very bottom floor is created to hold waste, a holding area.

19. A trash container for holding trash as in claim 1, wherein inflating tubes are all shapes such as round or square or triangle, etc.

20. A trash container for holding trash as in claim 1, wherein material of any kind to make a flexible wall.

21. A trash container for holding trash as in claim 1, wherein air or gas or fluids to inflate frame to produce a stable stand-alone trash container to hold trash with a balanced behavior.

22. A trash container for holding trash as in claim 1, wherein the trash container includes a mat which is absorbing to prevent liquids and or solid waste material from escaping from the frame on to the support surface.

23. A trash container for holding trash as in claim 1, wherein the trash container includes a mat which is non-absorbing to prevent liquids and or solid waste material from escaping from the frame on to the support surface.
